(19) United States
(12) Patent Application Publication
(10) Pub. No.: US 2005/0195421 A1
(43) Pub. Date: Sep. 8, 2005

(54) Method of producing authenticable and traceable hardcopies of electronically stored information sets

(76) Inventors: Mats Kihlen, Uppsala (SE); Andrew Mott, Knivsta (SE); Magnus Jansson, Stenhamra (SE)

Correspondence Address: FISH & RICHARDSON PC, 225 FRANKLIN ST, BOSTON, MA, 02110, US

(21) Appl. No.: 10/794,303

(22) Filed: Mar. 5, 2004

(51) Int. Cl. G06F 15/00

(52) U.S. Cl. 358/1.14

(57) ABSTRACT

A method and system for producing authenticable and traceable hardcopies of electronically stored information sets is disclosed. Printable versions of the electronically stored information sets are received and the printable versions of said electronically stored information sets are printed on a set of individually unique sheets of security paper. A correlation is stored of each information set of said electronically stored information sets with each sheet of the set of individually unique sheets of security paper having at least a portion of a printable version of the information set printed thereon.

### FIELD OF THE DISCLOSURE

The present disclosure relates to the storing of authenticable and traceable information. More specifically the present disclosure relates to a method of producing authenticable and traceable hardcopies of electronically stored information sets.

### BACKGROUND

The compiling, retrieving, recording, storing etc. of information is in many areas nowadays done almost exclusively using computers and computer storage means, since these offer several advantages in terms of e.g. speed, efficiency and capacity.

There are circumstances where storing of information by computer storage means is not sufficient, and hence, needs to be supplemented with storing of the information by additional storage means. One example is a case where it has to be possible to ensure that a stored set of information is authentic and to trace which date the set of information was stored. This is e.g. the case for research information including results, observations and conclusions etc., where such ability to authenticate the information and trace which date the information was stored may be essential in relation to patent issues.

Research information may be stored in bound laboratory notebooks in which a researcher enters research results which are then dated and witnessed. The research information may be handwritten and/or manual cut and pasted

### SUMMARY OF THE DISCLOSURE

According to the disclosure a method and a system for producing hardcopies of electronically stored information sets are provided. First a printable version of the electronically stored information sets is received. Then the printable versions of the electronically stored information sets are printed on a set of individually unique sheets of security paper. Finally, each information set of said electronically stored information sets is correlated with each sheet of the set of individually unique sheets of security paper having at least a portion of a printable version of the information set printed thereon.

As the correlation is done between the set of individually unique sheets of security paper and the respective electronically stored information sets, the correlation may be done in connection with the printing of the printable versions of the electronically stored information sets on the set of individually unique sheets of security paper. Furthermore, the identification of specific sheets of security paper correlated with an electronically stored information set at a later stage is enabled by means of the stored correlation. Hence, there is no need to assign or distribute the security papers to any individual user before the printout in order to produce authenticable and traceable hardcopies of electronically stored information sets. Furthermore, the use of a designated printer for printout on security paper of hardcopies of electronically stored information sets associated with different individual users is facilitated.

The term “security paper” is used herein to describe a type of paper for which each sheet of paper is unique, i.e. there are no identical sheets of paper and an organization using the paper cannot produce an identical copy of a sheet of paper. There are several types of paper which accomplish this, e.g. paper having special patterns, holograms, watermarks or other proofs which can be used to verify the paper's authenticity.

Unless otherwise defined, all technical and scientific terms used herein have the same meaning as commonly understood by those of ordinary skill in the art to which this invention belongs. Although methods and materials similar or equivalent to those described herein can be used in the practice or testing of the invention, suitable methods and materials are described below. All publications, patent applications, patents, and other references mentioned herein are incorporated by reference in their entirety. In case of a conflict in terminology, the present specification will control. In addition, the described materials and methods are illustrative only and are not intended to be limiting.

Other features and advantages of the invention will be apparent from the following detailed description and the claims.

### BRIEF DESCRIPTION OF THE DRAWINGS

In the following, embodiments of the present disclosure is illustrated by way of example and not limitation with reference to the accompanying drawings, in which:

FIG. 1 is a block diagram of a system in which embodiments of the disclosure are particularly applicable;

FIG. 2 is a flow chart of an embodiment of the method according to the disclosure; and

FIG. 3 is a block diagram of an embodiment of the system according to the disclosure.

### DETAILED DESCRIPTION OF THE DISCLOSURE

Embodiments of the disclosure will now be described. The general aim of the embodiments of the disclosure is to produce hardcopies of electronically stored research information sets in a form that enables the tracing of the date of the production of each research information set and the authentication of the identity between that stored research information set and the information produced on that date. The electronically stored research sets generally pertains to research records comprising e.g. results, observations and conclusions with respect to the research of researchers.

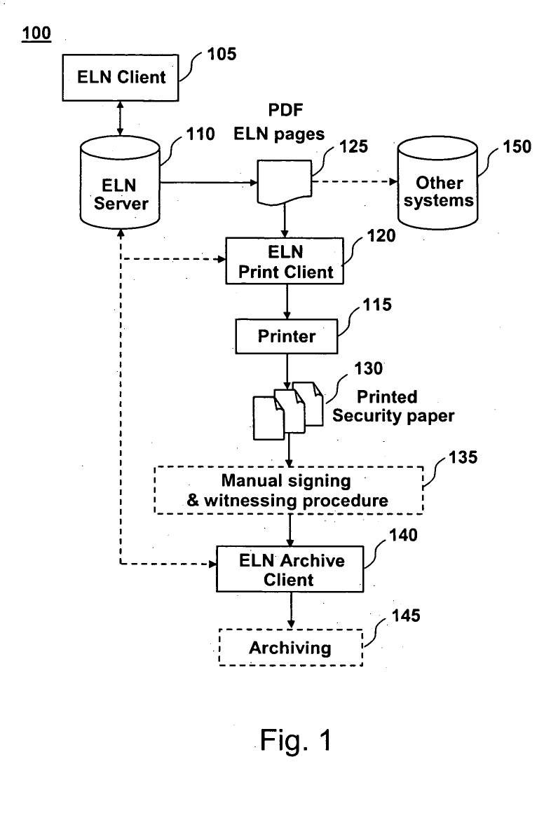

FIG. 1 is a block diagram of a system 100 in which embodiments of the disclosure are particularly applicable. An electronic laboratory notebook (ELN) system, comprising one or more ELN clients 105 and an ELN server 110, is arranged to handle and store research information sets. The ELN system (105, 110) is operatively connected to a printer 115 via an ELN Print Client 120, for printing printable versions 125, e.g. PDF format versions, of the research information sets. The printer 115 has been loaded with individually unique sheets of security paper 130 on which the printable versions 125 of the research information sets are printed. The security paper 130 is a type of paper for which each sheet of paper is unique, i.e. there are no identical sheets of paper and an organization using the paper cannot produce an identical copy of a sheet of paper. There are several types of paper which accomplish this, e.g. papers having special patterns, holograms, watermarks or other proofs which can be used to verify the paper's authenticity. The printout on the sheets of security paper 130 is followed by a manual signing and witnessing procedure 135 and the identification and recording of a correlation between each research information set and the sheet or sheets of security paper on which a printable version of the research information set is printed. The identification and storing is performed using an ELN Archive Client. Finally, the signed and witnessed sheets of security paper are archived 145.

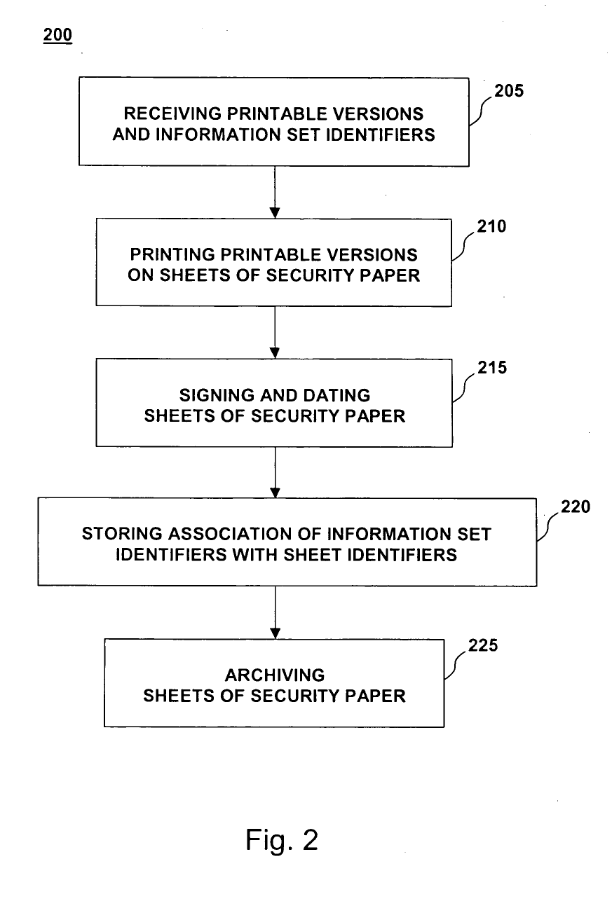

FIG. 2 is a flow chart of an embodiment of the method according to the disclosure. A research information set has been associated with an unique research information set identifier and a printable version of the research information set has been produced, e.g. in an ELN system as disclosed in FIG. 1. In step 205, the printable version of the research information set is received at a printer site together with the research information set identifier.

The research information set identifier may for example be received as a barcode on the printable version of the research information set. This may be achieved in the system 100 of FIG. 1 according to the following. When a researcher wishes to produce a hardcopy of a research information set, such as a completed part of an experiment, the research information set in the ELN system is locked for further editing through a submission procedure, where the user submits the research information set for printout. Furthermore, when the researcher submits the research information set for printout, page-breaking is performed and the printable version 125 produced will include a barcode indicating the research information set identifier on one or more of the pages of the printable version 125. In one alternative, a barcode is included on each page of the printable version of the research information set, wherein the barcode indicates a unique identifier of the respective page. Of course any alternative to barcodes may be used to provide the identifier of the submitted information set, including an alternative where the identifier is provided separately from, but associated with, the printable version of the research information set.

At the printer site, a printer has been loaded with individually unique sheets of security paper. Preferably, each of the sheets is associated with a respective unique sheet identifier. The sheets may e.g. each have a barcode printed thereon, each barcode indicating the unique sheet identifiers of the respective sheet. Of course any type of identifier may be used for identifying each sheet of security paper. Furthermore, the sheets of security paper are preferably numbered consecutively.

In a step 210 the printable version of the research information set is printed on sheets of security paper of the sheets loaded in the printer. The printing is preferably performed in such a way that consecutive pages of the printable version of the research information set are printed on consecutively numbered sheets of security paper.

After the printout of the printable version of the research information set, the sheets of this hardcopy are signed and dated by the researcher and a witness in step 215. Of course any other way of providing proof that the hardcopy was produced on a specific date could replace the step of signing and dating.

Furthermore, in step 220 an association is identified of the research information set identifier of the information set with the sheet identifiers of the sheets on which the printable version of the research information set was printed in step 210. The association is then stored in a register. In the case where the printable version of the research information set has been provided with a barcode indicating the research information set identifier and each sheet of security paper has been provided with a barcode indicating the sheet identifier, the association of the information set identifier with the sheet identifiers may be identified by means of optical scanning of the barcodes. Hence, a fully automated association may be achieved, e.g. by arranging an optical scanner in connection with the printer. Each printed sheet of security paper could be automatically fed into the optical scanner which scans the barcodes printed on the sheet. The information set identifier and sheet identifier indicated by means of the barcodes are then automatically associated with each other and the association is forwarded to a register where it is stored. In the case where each page of the printable version of the research information set has been provided with a respective barcode including an identifier of the page, an association of each page of the research information set with a respective sheet identifier may be identified by means of optical scanning of the barcodes.

Finally, in step 225 the printed sheets of security paper which have been signed and dated by the researcher and the witness are archived. In the case where consecutive pages of the printable version of the research information set have been printed on consecutively numbered sheets of security paper, the sheets of security paper are preferably archived in number order. In this way, relevant archived sheets are easily found in case of later need for retrieval. It is to be noted that even though the consecutive numbering and archiving of the sheets of security paper is preferred, it is not essential. More specifically, any way of ordering of the archived sheets of security paper may be used which enables the later retrieval based on the association of an research information set identifier with the sheet identifiers of the sheets of security paper on which a printable version of the research information set was printed.

A further step may optionally be added before the archiving, where the sheets of security paper are optically scanned in order to verify that all sheets have been signed and dated.

By means of applying the embodiment of FIG. 2 in the system of FIG. 1, it is possible to have several researchers printing out respective research information sets on a single printer. In the most preferred embodiment, numbered sheets of security paper are loaded in the printer so that they are printed in number order. Printable versions of research information sets submitted by researchers are then printed consecutively on the numbered sheets. The printed sheets are then archived in number order after being duly signed and witnessed. It is then sufficient to store an association between the unique identifier of each printed research information set and the corresponding starting sheet number and ending sheet number in order to enable simple means for retrieving the hardcopy of a research information set from the archive at a later stage.

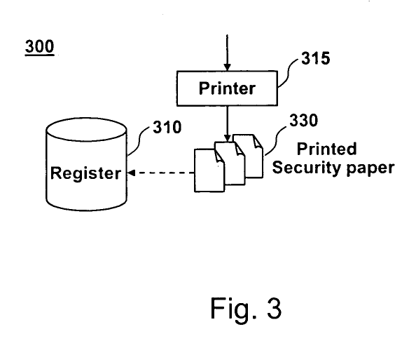

In FIG. 3 a block diagram of a system 300 according to the disclosure is disclosed. The system comprises a printer 315, which e.g. may be connected to an ELN system according to FIG. 1. The printer 315 is arranged to receive printable versions of research information sets together with research information set identifiers of these research information sets.

The research information set identifiers may for example be received as barcodes on the printable versions of the research information set, as described with reference to FIG. 2 and FIG. 1. The printer has been loaded with individually unique sheets of security paper, each preferably being associated with a respective unique sheet identifier, e.g. by means of a barcode printed thereon, each barcode indicating the unique sheet identifiers of the respective sheet. Furthermore, the sheets of security paper are preferably numbered consecutively.

The printer 315 is arranged to print the printable versions of the research information sets on sheets of security paper 330 of the sheets loaded in the printer. The printing is preferably performed in such a way that consecutive pages of the printable version of the research information set are printed on consecutively numbered sheets of security paper 330.

The system 300 further comprises a register 310, in which an identified association is stored of the research information set identifier of the information set with the sheet identifiers of the sheets on which the printable version of the research information set was printed.

The system 300 may optionally comprise an optical scanner (not shown) for optical reading of barcodes. In the case where the printable version of the research information set has been provided with a barcode indicating the research information set identifier and each sheet of security paper has been provided with a barcode indicating the sheet identifier, the association of the information set identifier with the sheet identifiers may be identified by means of the optical scanner. In the case where each page of the printable version of the research information set has been provided with a respective barcode including an identifier of the page, an association of each page of the research information set with a respective sheet identifier may be identified by means of the optical scanner.

Various features of the system can be implemented in hardware, software, or a combination of hardware and software. For example, some aspects of the system can be implemented in computer programs executing on programmable computers. Each program can be implemented in a high level procedural or object-oriented programming language to communicate with a computer system.

Furthermore, each such computer program can be stored on a storage medium, such as read-only-memory (ROM), readable by a general or special purpose programmable computer, for configuring and operating the computer when the storage medium is read by the computer to perform the functions described above.

Other implementations are within the scope of the following claims.

1. A method of producing hardcopies of electronically stored information sets, comprising:
receiving printable versions of the electronically stored information sets;
printing the printable versions of the electronically stored information sets on a set of individually unique sheets of security paper; and
storing a correlation of each information set of the electronically stored information sets with each sheet of the set of individually unique sheets of security paper having at least a portion of a printable version of the information set printed thereon.

2. The method of claim 1, wherein the printing is performed by means of a designated printer comprising the set of individually unique sheets of security paper.

3. The method of claim 1, wherein each information set of the electronically stored information sets is associated with a respective unique information set identifier, each sheet of the set of individually unique sheets of security paper is associated with a respective unique sheet identifier, and the storing comprises:
storing in a register an association of a unique information set identifier of each information set of the electronically stored information sets with a unique sheet identifier of each sheet of the set of individually unique sheets of security paper having at least a portion of a printable version of the information set printed thereon.

4. The method of claim 1, wherein the set of individually unique sheets of security paper in the designated printer are numbered consecutively.

5. The method of claim 1, further comprising:
signing and dating the set of individually unique sheets of security paper having the printable versions of the electronically stored information sets printed thereon.

6. The method of claim 5, wherein the signing and dating is performed both by a respective user and witness.

7. The method according to claim 1, further comprising:
archiving the set of individually unique sheets of security paper having the printable versions of the electronically stored information sets printed thereon.

8. A system for producing hardcopies of electronically stored information sets, comprising:
a printer for receiving and printing printable versions of the information sets on a set of individually unique sheets of security paper; and
a register for storing a correlation of each information set of the electronically stored information sets with each sheet of the set of individually unique sheets of security paper having at least a portion of a printable version of the information set printed thereon.

9. The system of claim 8, wherein each information set of the electronically stored information sets is associated with a respective unique information set identifier, each sheet of the set of individually unique sheets of security paper is associated with a respective unique sheet identifier, and the correlation stored in the register is an association of a unique information set identifier of each information set of the electronically stored information sets with a unique sheet identifier of each sheet of the set of individually unique sheets of security paper having at least a portion of a printable version of the information set printed thereon.

10. The system of claim 8, wherein the set of individually unique sheets of security paper are numbered consecutively.

11. The system of claim 8, further comprising:
an archive for storing the set of individually unique sheets of security paper having the printable versions of the electronically stored information set printed thereon.

12. A method of producing hardcopies of research information sets stored in electronic laboratory notebooks, wherein each research information set of the research information sets is associated with a respective unique research information set identifier, comprising:
providing a set of individually unique sheets of security paper in a designated printer, wherein each sheet of the individually unique sheets of security paper is associated with a respective unique sheet identifier;
receiving printable versions of the research information sets together with the unique research information set identifiers;
printing the printable versions of the research information sets on the set of individually unique sheets of security paper; and
storing in a register an association of a unique information set identifier of each information set of the electronically stored information sets with a unique sheet identifier of each sheet of the set of individually unique sheets of security paper having at least a portion of a printable version of the information set printed thereon.

13. The method of claim 12, wherein the set of individually unique sheets of security paper in the designated printer are numbered consecutively.

14. A system for producing hardcopies of research information sets stored in electronic laboratory notebooks, wherein each research information set of the research information sets is associated with a respective unique research information set identifier, comprising:
a printer for receiving printable versions of the research information sets together with the unique research information set identifiers, and for printing the printable versions of the research information sets on a set of individually unique sheets of security paper, wherein each sheet of the individually unique sheets of security paper is associated with a respective unique sheet identifier; and
a register for storing an association of a unique information set identifier of each information set of the electronically stored information sets with a unique sheet identifier of each sheet of the set of individually unique sheets of security paper having at least a portion of a printable version of the information set printed thereon.

15. The system of claim 14, wherein the set of individually unique sheets of security paper in the printer are numbered consecutively.

16. A system for producing hardcopies of research information sets stored in electronic laboratory notebooks comprising:
a network; and
a network device communicatively coupled to the network, the device including a processor and instructions executable by the processor to cause the processor to:
receive printable versions of the electronically stored information sets;
print the printable versions of the electronically stored information sets on a set of individually unique sheets of security paper; and
store a correlation of each information set of the electronically stored information sets with each sheet of the set of individually unique sheets of security paper having at least a portion of a printable version of the information set printed thereon.

17. The system of claim 16, wherein the printing is performed by means of a designated printer comprising the set of individually unique sheets of security paper.

18. The system of claim 16, wherein the set of individually unique sheets of security paper in the designated printer are numbered consecutively.
